(19) United States
(12) Patent Application Publication
(10) Pub. No.: US 2024/0394449 A1
(43) Pub. Date: Nov. 28, 2024

(54) CIRCUIT DESIGN METHOD AND APPARATUS

(71) Applicant: SEOUL NATIONAL UNIVERSITY R&DB FOUNDATION, Seoul (KR)

(72) Inventors: Dongsuk JEON, Seoul (KR); Ji Woo HONG, Seoul (KR)

(21) Appl. No.: 18/795,368

(22) Filed: Aug. 6, 2024

Related U.S. Application Data
(63) Continuation of application No. PCT/KR2023/002588, filed on Feb. 23, 2023.

(30) Foreign Application Priority Data
Nov. 15, 2022 (KR) 10-2022-0153093

(51) Int. Cl. G06F 30/33

(52) U.S. Cl. CPC G06F 30/33

(57) ABSTRACT

Proposed is a circuit design method and device that automatically designs circuits by generating candidate circuit structures and optimizing transistor sizes. According to the circuit design method and device, design time and cost are reduced, and circuit performance is improved. The circuit design method may comprise: generating, by a processor, a candidate circuit structure by executing a genetic algorithm based on a gene and associated with a circuit topology graph; and optimizing, by the processor, a transistor size of the candidate circuit structure by executing a reinforcement learning algorithm based on analysis of multiple process corners.

### CROSS-REFERENCE TO RELATED APPLICATION

This application claims priority to and the benefit of PCT Patent Application No. PCT/KR2023/002588 filed on Feb. 23, 2023, and Korean Patent Application No. 10-2022-0153093 filed in the Korean Intellectual Property Office on Nov. 15, 2022, the entire contents of which are incorporated herein by reference.

### BACKGROUND

The present disclosure relates to a circuit design method and device, and to a method and device for automatically designing a circuit by generating a candidate circuit structure and optimizing transistor sizes.

The description below is merely for the purpose of providing background information on embodiments of the present disclosure, and does not constitute the conventional arts.

Recently, the difficulty of IC design has increased exponentially due to continuous process miniaturization, and as process variation increases, a lot of time is being spent on optimizing a circuit structure and transistor size to obtain optimal performance.

Circuit design automation algorithms developed to date focus on one of two processes including circuit topology generation and transistor size optimization. Therefore, the entire process may not be automated, and performance is reduced compared to circuits designed by experts.

The circuit structure searched by a circuit structure search algorithm does not reflect the characteristics (for example, characteristics in which P-channel metal oxide semiconductor (PMOS) transistors are mainly placed on a high voltage side and N-channel metal oxide semiconductor (NMOS) transistors are mainly placed on a low voltage side) of a complementary metal oxide semiconductor (CMOS) process, and accordingly, many meaningless circuit structures are searched, the search speed and efficiency are reduced. In addition, because pre-built libraries or building blocks are mostly used, there are limitations in that only certain types of circuits are applied therefor.

Because the conventional transistor size optimization algorithms do not reflect process variations in an optimization process, there is a problem in that an optimized circuit may not operate normally under process variations and it is difficult to achieve target performance.

Meanwhile, the conventional art described above is technical information that an inventor possesses for deriving the present disclosure or acquires in the process of deriving the present disclosure and is not necessarily the known technology disclosed to the general public before the present disclosure is filed.

### SUMMARY

The present disclosure provides a circuit design method and device for automatically designing a circuit by generating a candidate circuit structure and optimizing a transistor size.

Also, the present disclosure provides a circuit design automation framework for an optimal circuit design that achieves target performance by using a genetic algorithm and reinforcement learning.

Objects of the present disclosure are not limited to the objects described above, and other objects and advantages of the present disclosure that are not described may be understood through the following description and will be more clearly understood through examples of the present disclosure. It will also be appreciated that the objects and advantages of the present disclosure may be realized by structures and combinations thereof as set forth in the claims.

According to an aspect of embodiment, a circuit design method, which is performed by a circuit design apparatus including a processor, includes generating, by a processor, a candidate circuit structure by executing a genetic algorithm based on a gene and associated with a circuit topology graph, and optimizing, by the processor, a transistor size of the candidate circuit structure by executing a reinforcement learning algorithm based on analysis of multiple process corners.

According to another aspect of embodiment, a circuit design apparatus includes a memory storing at least one instruction, and a processor, wherein, when the at least one instruction is executed by the processor, the processor is configured to generate a candidate circuit structure by executing a genetic algorithm based on a gene and associated with a circuit topology graph, and optimize a transistor size of the candidate circuit structure by executing a reinforcement learning algorithm based on analysis of multiple process corners.

Other aspects, features, and advantages in addition to the description above will become apparent from the following drawings, claims, and detailed description of the invention.

According to the embodiment, the circuit design process may be performed automatically, and therethrough, the cost and time required for circuit design may be significantly reduced.

Also, automation may be simply performed, and higher performance may be obtained compared to the circuit designed directly by a design expert.

Effects of the present disclosure are not limited to the effects described above, and other effects not described will be clearly understood by those skilled in the art from the above description.

### BRIEF DESCRIPTION OF THE DRAWINGS

Embodiments of the inventive concept will be more clearly understood from the following detailed description taken in conjunction with the accompanying drawings in which:

FIG. 1 schematically illustrates a circuit design framework according to an embodiment;

FIG. 2 is a block diagram of a circuit design apparatus according to an embodiment;

FIG. 3 is a flowchart of a circuit design method according to an embodiment;

FIG. 4 is an example diagram of a circuit topology graph used for circuit design, according to an embodiment;

FIG. 5 is a pseudocode of a candidate circuit structure generation process according to an embodiment; and

FIG. 6 is a pseudocode of a transistor size optimization process according to an embodiment.

### DETAILED DESCRIPTION OF THE EMBODIMENTS

Hereafter, the present disclosure will be described in detail with reference to the drawings. The present disclosure may be implemented in many different forms and is not limited to the embodiments described herein. In the following embodiments, parts that are not directly related to the description are omitted to clearly describe the present disclosure, but this does not mean that such omitted parts are unnecessary in implementing a device or system to which the idea of the present disclosure is applied. In addition, the same reference numbers are used for identical or similar components throughout the specification.

In the following description, terms, such as first, second, and so on, may be used to describe various components, but the components should not be limited by the terms, and the terms are used only for the purpose of distinguishing one component from another component. Also, in the following description, singular expressions include plural expressions, unless the context clearly dictates otherwise.

In the following description, it should be understood that terms, such as “comprise”, “include”, or “have”, are intended to designate the presence of features, numbers, steps, operations, configuration elements, components, or combinations thereof described in the specification, and do not preclude the presence or addition of one or more other features, numbers, steps, operations, configuration elements, components, or combinations thereof.

The present disclosure will be described in detail below with reference to the drawings.

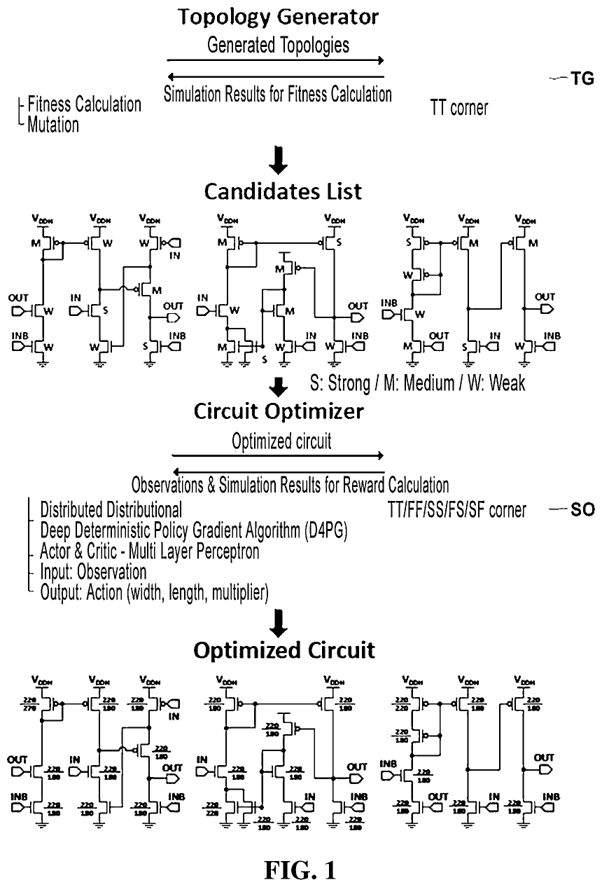

FIG. 1 schematically illustrates a circuit design framework according to an embodiment.

A circuit design includes a topology generation (TG) process and a size optimization (SO) process for each transistor. Recently, research has been actively conducted to automate a circuit design by using artificial intelligence technology, but only one of the two processes is being implemented.

The present disclosure proposes a circuit design automation framework that may perform both TG and SO.

When a user provides target performance (design constraints) of a circuit, the circuit design framework according to the embodiment automatically finds the optimal circuit structure and even performs size optimization based thereon, and thereby, the entire process of the circuit design may be automated without user intervention.

The TG process, which is a first process, searches for candidates for a circuit structure that appear to be able to roughly achieve the target performance. This corresponds to step S1 illustrated in FIG. 3.

Because the size of each transistor is not optimized, the size of a transistor needs to be roughly determined as weak/medium/strong, and so on, and a genetic algorithm automatically adds/deletes/changes transistors to find circuits that operate normally.

After the search process is completed, the obtained circuit structure candidates are transferred to SO process that is a second step.

In the second step, a reinforcement learning algorithm is applied to each candidate structure to optimize the transistor size. This corresponds to a second step S2 illustrated in FIG. 3.

Meanwhile, the circuit design framework according to the embodiment simulates may use a simulation (for example, the SPICE Simulation) result as needed to calculate the fitness of a circuit structure generated in the step TG and to calculate reward according to the transistor size changed in the step SO.

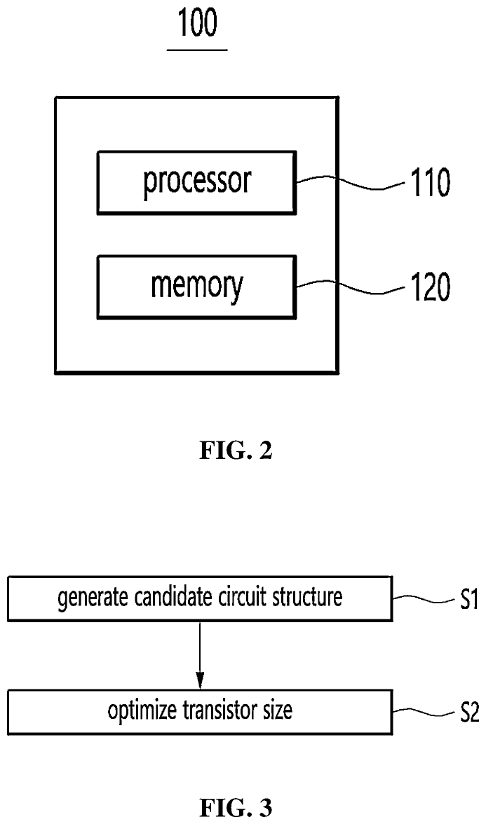

FIG. 2 is a block diagram of a circuit design apparatus according to an embodiment.

A circuit design apparatus 100 according to an embodiment may include a processor 110 and a memory 120. This configuration is an example, and the circuit design apparatus 100 may include some of the configurations illustrated in FIG. 2 or may additionally include configurations that are not illustrated in FIG. 2 but are required to operate the circuit design apparatus 100.

The circuit design apparatus 100 may include a memory 120 and a processor 110 that store at least one instruction.

The processor 110 may a type of central processing unit and may execute one or more instructions stored in the memory 120 to perform a circuit design method according to an embodiment.

The processor 110 may include all types of devices capable of processing data. The processor 110 may refer to, for example, a data processing device built in hardware which includes a physically structured circuit to perform a function represented by codes or instructions included in a program.

The data processing device, which is built in hardware, may include a microprocessor, central processing unit (CPU), a processor core, a multiprocessor, an application-specific integrated circuit (ASIC), a field programmable gate array (FPGA), or so on but is not limited thereto.

The processor 110 may include at least one processor. The processor 110 may include at least one processor disposed in a plurality of computing devices.

For example, the plurality of computing devices may include a computing device for generating a candidate circuit structure, which is described below, and a computing device for optimizing a transistor size. For example, the plurality of computing devices may include a computing device that executes a learner for optimizing a transistor size and a computing device that executes an agent.

The memory 120 may store a program including at least one instruction. The processor 110 may perform a circuit structure design process according to an embodiment based on a program and instructions stored in the memory 120.

The memory 120 may further store intermediate data and calculation results generated during a calculation process of a genetic algorithm and a reinforcement learning algorithm during the circuit structure design process according to the embodiment.

The memory 120 may include an internal memory and/or an external memory, for example, a volatile memory such as dynamic random access memory (DRAM), static RAM (SRAM), or synchronous DRAM (SDRAM), a non-volatile memory such as one time programmable read only memory (OTPROM), programmable ROM (PROM), erasable PROM (EPROM), electrically EPROM EEPROM), mask ROM, flash ROM, NAND flash memory, or NOR flash memory, a flash drive such as a solid state drive (SSD), a compact flash (CF) card, a secure digital (SD) card, a micro-SD card, a mini-SD card, an extreme digital (xD) card, or a memory stick, or a storage device such as a hard disk drive (HDD). The memory 120 may include magnetic storage media or flash storage media but is not limited thereto.

The circuit design apparatus 100 according to the embodiment may include the memory 120 storing at least one instruction and the processor 110, and when the at least one instruction stored in the memory 120 is executed by the processor 110, the processor 110 may generate a candidate circuit structure by executing a gene-based genetic algorithm linked to a circuit topology graph and execute a multiple process corner analysis-based reinforcement learning algorithm to optimize a transistor size of the candidate circuit structure.

Here, the gene may be linked to a node in a circuit topology graph and may be linked to node gene that reflects node properties of a circuit structure and an edge of the circuit topology graph and may include a connection gene that reflects transistor properties of the circuit structure.

The gene may include a relative voltage of a node of the circuit topology graph, and when at least one instruction stored in memory 120 is executed by the processor 110, the processor 110 may determine a relative voltage of an edge based on the relative voltage of nodes at both ends of the edge of the circuit topology graph representing the optimized candidate circuit structure and may convert a transistor associated with the edge into a PMOS transistor or an NMOS transistor in an optimized candidate circuit structure according to the relative voltage of the edge.

To execute the genetic algorithm, when at least one instruction stored in the memory 120 is executed by the processor 110, the processor 110 may generate a new offspring from the belonging to the current population as each species to which the offspring belongs.

For example, in order to generate a new offspring, when at least one instruction stored in the memory 120 is executed by the processor 110, the processor 110 may generate a new offspring by crossing over a pair of offsprings selected from a parent pool including at least some of the offsprings belonging to each species to each species to which the offsprings belong from an offspring belonging to the current population, perform mutation on the new offspring, and add the mutated offspring to the next generation population.

For example, in order to perform the above-described mutation, when at least one instruction stored in the memory 120 is executed by processor 110, the processor 110 may probabilistically perform a change in transistor size, connection removal, addition, a gate change, and an output port change. Here, the addition may be one of a connection addition, a node addition, and addition of a PMOS transistor and an NMOS transistor.

In order to execute a genetic algorithm, when at least one instruction stored in the memory 120 is executed by the processor 110, the processor 110 may determine the fitness of species based on the fitness of offspring belonging to the current population, determine a reproduction size of species based on the fitness of species, repeat the step of generating new offspring as many times as the reproduction size of species, and classify species of the offspring belonging to the next population.

Next, the step of determining the fitness of species by using the next population as the current population, the step of determining the reproduction size of species, the step of repeating the step of generating new offspring as many as the reproduction size of species, and the step of classifying species are repeated for the maximum number of generations, and the offspring with the highest fitness of species may be extracted as a candidate circuit structure.

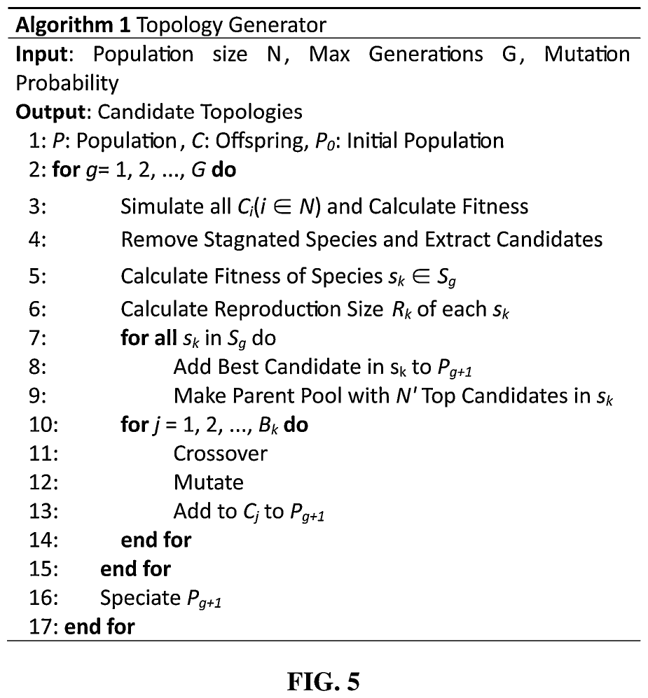

In order to avoid redundant description, details of generation of a candidate circuit structure will be described below with reference to FIGS. 3 and 5.

Meanwhile, multi-process corners may include a TT corner, an FF corner, an SS corner, an FS corner, and an SF corner, and in order to optimize a transistor size of the candidate circuit structure, when at least one instruction stored in the memory 120 is executed by the processor 110, the processor 110 may execute a reinforcement learning algorithm based on the worst case performance among performances of the candidate circuit structure identified in each process corner.

Here, in order to execute the reinforcement learning algorithm, when at least one instruction stored in the memory 120 is executed by the processor 110, the processor 110 may execute a learner to generate a plurality of agents based on a reinforcement learning network and to update the reinforcement learning network based on a sample received from plurality of agents.

Here, in order to update the reinforcement learning network, the processor 110 may repeat, by a predetermined number of updates, an operation of selecting a sample having a predetermined batch size from samples received from the plurality of agents, and an operation of updating the reinforcement learning network based on the selected sample.

When at least one instruction stored in memory 120 is executed by the processor 110, the processor 110 may repeat, by a predetermined number of updates, an operation of performing an action associated with a change in transistor size of the candidate circuit structure based on a current state by each of the plurality of agents to provide a sample, an operation of determining reward and a next state according to the action, and an operation of generating a sample based on the current state, action, next state, and reward and transferring the generated samples to a learner.

Here, the number of repetitions may increase by a predetermined amount at each predetermined interval.

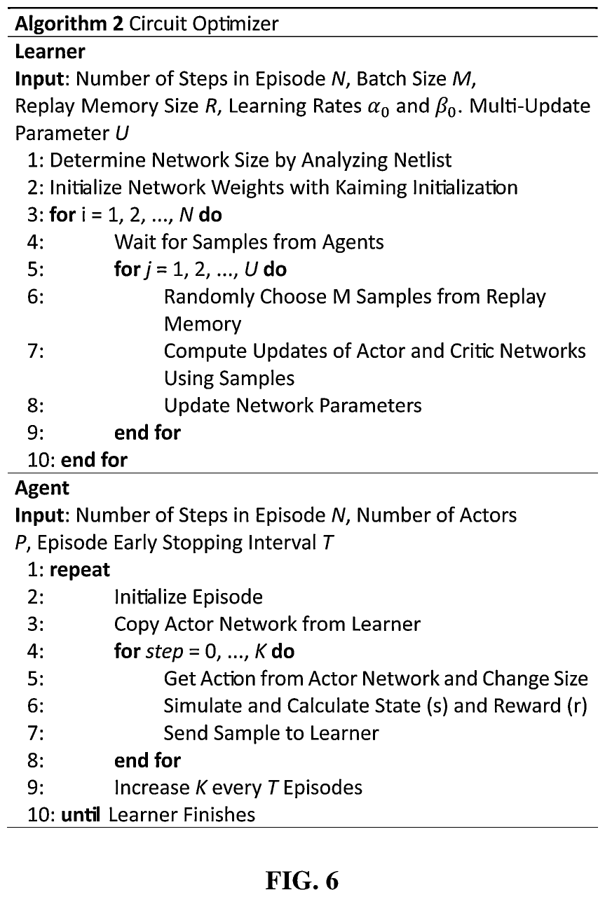

To avoid redundant description, details of transistor size optimization will be described below with reference to FIGS. 3 and 6.

Hereinafter, a circuit design process according to an embodiment will be described in detail with reference to FIGS. 3 to 6.

FIG. 3 is a flowchart of a circuit design method according to an embodiment.

The circuit design method according to the embodiment is a circuit design method performed by the circuit design apparatus 100 including the processor 110, and includes step S1 of generating, by the processor 110, a candidate circuit structure by executing a gene-based genetic algorithm linked to a circuit topology graph, and step S2 of executing, by the processor 100, a reinforcement learning algorithm based on analysis of multiple process corners to optimize a transistor size of the candidate circuit structure.

In step S1, the processor 100 generates a candidate circuit structure by executing a gene-based genetic algorithm linked to the circuit topology graph.

In step S1, the genetic algorithm is applied to automatically add/delete/change a size of a transistor, change connection of nodes, and so on and to search for a suitable circuit structure. This will be described in detail with reference to FIG. 5.

In step S2, the processor 110 executes a reinforcement learning algorithm based on analysis of multiple process corners to optimize a transistor size of the candidate circuit structure. This will be described in detail with reference to FIG. 6.

In one example, step S1 and step S2 may be performed sequentially. In one example, step S1 and step S2 may be performed in parallel. In one example, the circuit design apparatus 100 may include at least one processor 110, and step S1 and step S2 may each be executed by a separate processor. In one example, step S1 and step S2 may be executed by the same computing device or different computing devices.

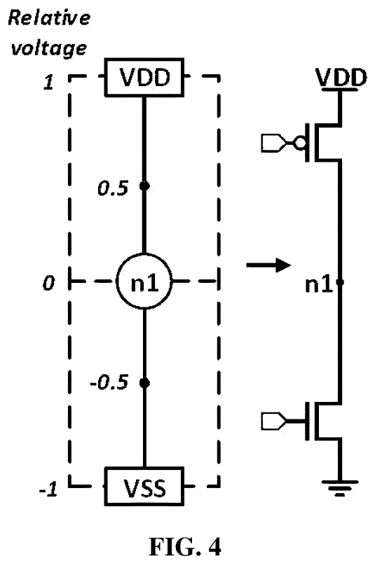

Before describing in detail the circuit design method according to the embodiment, a circuit topology graph will be described with reference to FIG. 4.

FIG. 4 is an example diagram of the circuit topology graph used for circuit design according to an embodiment.

In step S1, a structure of each circuit is shown as a circuit topology graph to execute the genetic algorithm.

Nodes of the circuit topology graph correspond to nodes of an actual circuit, and edges of the circuit topology graph represent transistors of the actual circuit.

For example, in FIG. 4, a node (for example, N1) of the circuit topology graph corresponds to a node of an actual circuit, and edges connected to the node corresponds to transistors.

Meanwhile, in the graph representation method proposed by the present disclosure, the edges and node of the circuit topology graph have relative voltages. The relative voltage of an edge may be determined as an average value of the relative voltages at both ends of the edge.

For example, an average value 0.5 of the relative voltage 1 of a power supply voltage VDD and the relative voltage 0 of the node N1 may be determined as the relative voltage 0.5 of the edge between the power supply voltage VDD and the node N1.

The circuit design apparatus 100 according to the embodiment may converts the edge into a PMOS transistor when the relative voltage of the edge of the circuit topology graph is relatively high (for example, a positive number), and may convert the edge into an NMOS transistor when the relative voltage of the edge is relatively low (for example, 0 or a negative number).

As a result, circuits designed in the CMOS process may effectively reflect design characteristics of CMOS circuits in which a PMOS transistor is disposed on a high voltage side and an NMOS transistor is disposed on a low voltage side regardless of digital and analog circuits.

For example, an edge (a relative voltage of 0.5 V) between the power supply voltage VDD and the node N1 may be converted into a PMOS transistor, and an edge between a power supply voltage VSS and the node N1 (a relative voltage of −0.5 V) may be converted into an NMOS transistor.

Meanwhile, the exemplary circuit topology graph illustrated in FIG. 4 corresponds to a circuit structure of an offspring (that is, a circuit topology graph including three node genes and two connection genes) set as an initial population P0 of step S1 to be described below with reference to FIG. 5. In other words, the initial population P0 includes an offspring including the power supply voltages VDD and VSS and one internal node connected to the power supply voltages VDD and VSS through a pair of PMOS and NMOS transistors and executes a genetic algorithm using the offspring as a starting point.

FIG. 5 is a pseudocode of a candidate circuit structure generation process according to an embodiment.

Step S1 searches for a circuit structure candidate group expected to be able to achieve the target performance and constraints of a circuit input by a user. In this case, in order to maximize a search speed, a coarse search is performed by broadly dividing into weak/medium/strong, and so on without precisely optimizing a size of each transistor.

In step S1, by a processor generates a candidate circuit structure by executing a gene-based genetic algorithm linked to the circuit topology graph.

The genetic algorithm for generating the candidate circuit structures performs an evolutionary operation including crossover, mutation, and so on based on a gene linked to the circuit topology graph.

Here, the gene includes a node gene that is linked to a node in the circuit topology graph and reflects node properties of the circuit structure, and a connection gene that is linked to an edge of the circuit topology graph and reflects the transistor properties of the circuit structure.

The node gene includes a node type, a relative voltage of the node, and a node identifier.

The node type is a property indicating the type of node, such as an input port, an output port, supply, ground, or an internal net. The relative voltage of the node is a relative voltage of the node described above with reference to FIG. 4, and has a range from, for example, −1 to 1. The node identifier is a unique identification number of a node.

The connection gene include a source, a drain, a size, a gate, and a connection identifier.

The source and drain are points at both ends of an edge and refer to a source and drain of a transistor corresponding to the edge. The size represents a relative strength of a transistor, and the gate represents a node to which the gate of a transistor is connected. The connection identifier refers to a unique identification number.

Referring to FIG. 5, the gene-based genetic algorithm linked to the circuit topology graph in step S1 receives a candidate a population size N, a maximum generation number G, and mutation probability and outputs a candidate circuit topology.

Step S1 includes a step (line 5) of determining the fitness of species based on the fitness (line 3) of a offspring C belonging to a current population P (line 3), a step (line 6) of determining a reproductive size Rk for each species based on the determined fitness of species, a step (lines 7-15) of repeating the step of generating new offspring as many times as the reproduction size Rk for each species, and a step (line 16) of classifying species of the offspring belonging to the next population.

Here, the step of generating the new offspring may include a step of generating a new offspring for each species to which the offspring belongs from the offspring belonging to the current population.

That is, the step of generating the new offspring includes a step (line 9 and line 11) of generating the new offspring by crossing over a pair of offsprings selected from a parent pool including at least some of the offsprings C belonging to each species Sk to each species Sk to which the offsprings C belong from an offspring C belonging to the current population P, a step (line 12) of performing mutation on the new offspring, and a step (line 13) of adding the mutated offspring to the next generation population Pg+1.

Here, the step (line 12) of performing the mutation may include a step of probabilistically perform a change in transistor size, connection removal, addition, a gate change, and an output port change, and the addition may be one of a connection addition, a node addition, and addition of a PMOS transistor and an NMOS transistor.

Also, step S1 includes a step (line 5) of determining the fitness of species by using the next population Pg+1 as the current population, a step (line 6) of determining the reproduction size of species, and a step (line 2) of repeating a repetition step (lines 7-15) and a classifying step (line 16) up to the maximum number of generations G.

In addition, step S1 further includes a step of finally extracting the best candidate in Sk as a candidate circuit structure after the algorithm of FIG. 5 is completed.

Referring to FIG. 5, the pseudocode is described for each line.

Step S1 generates a candidate circuit structure by executing a following genetic algorithm.

Input: Number of population N, maximum number of generations G, each mutation probability.

In the initialization step (line 1), N offsprings C are generated as the initial population P0. In this case, all offspring belong to one species. Each offspring has a gene including node and connection information.

The following processes (line 2 to line 17) are performed for each generation.

—Start a step performed at each generation (line 2)—
1) Each offspring Ci is simulated and the fitness of offspring is calculated by using the simulation result (line 3).

For example, the fitness may be calculated by Equation 1 below:

$$f {t}_{x} = {\sum }_{i ∈ H} {α}_{i} f ( {q}_{i , x} ) + [ {\prod }_{i ∈ H} f ( {q}_{i , x} ) ] [ {\sum }_{j ∈ S} {α}_{i} f ( {q}_{j , x} ) ] \qquad Equation 1$$

where fitₓ is the fitness of an offspring Cₓ, q_{i,x} represents the circuit performance expected by simulation associated with the i-th constraint, f(q_{i,x}) is a score function for each constraint, and αᵢ represents a weighted value of the i-th constraint. H and S respectively represent the first constraint set and the second constraint set.

The fitness fitₓ of Equation 1 may represent the performance and reliability of a circuit as a single value. Two types of design constraints are considered here, and the first constraint set H is a set of design constraints (for example, rail-to-rail output swing in a case of a level shifter circuit) that a circuit needs to satisfy), and the second constraint set S is a set of design quality constraints (for example, power consumption and conversion delay in the case of a level shifter circuit).

As may be seen in Equation 1, the contribution to the fitness of the second constraint set S is normalized by scores related to the first constraint set H. This means that in the early generations, most of the offsprings may fail to function properly, and in this case, the score associated with the first constraint set H is very low, and accordingly, the fitness calculated by using Equation 1 is largely dictated by the first constraint condition H. Accordingly, finding an operating topology may be focused, and chances of finding an ideal candidate is increased. When a circuit topology that operates normally is found, the score associated with the first constraint set H is saturated and does not affect the fitness. The other genetic processes further modify the circuit topology to improve the circuit performance (that is, the second constraint set S).
2) It is checked whether the fitness of an offspring belonging to each species is improved (line 4).

For example, when a max fitness value of an offspring belonging to a given species is not increased during a specific generation period, it is determined to be stagnated, and the offspring belonging to the given species is removed. In this case, the offspring with excellent fitness is extracted as a candidate for step S2 from the species being removed (line 4).
3) The fitness of species score for the next generation differentiation is calculated (line 5). For example, the score is obtained by subtracting the smallest fitness value among all offsprings from an average value of fitness scores of offsprings belonging to the species.
4) An offspring size Rk to be reproduced for each species is calculated based on the obtained fitness value of the species (line 6). However, all Species has to generate at least two offsprings for the next generation.
   —Start of steps for each species (line 7)—
5) In the Species, an offspring with the best fitness are input to the next generation population as it is (line 8).
6) N′ offsprings are input to a parent pool in order of good fitness in species (line 9).
7) Crossover step (line 11). For example, in the crossover step, two offsprings are randomly selected from the parent pool, and an offspring having a better fitness value is reflected in a newly generated offspring. In this case, several genes of offsprings with low fitness are each added to a gene of an offspring with better fitness in a certain probability or change in value.
8) Mutation step (line 12). In the crossover step, a gene of the newly generated offspring is changed through mutation. For example, mutation occurs with a certain probability at each step, and each step is illustratively as follows.

Size change→Remove Connection→one of Add connection/add node/add N-channel MOSFET & N-channel MOSFET is selected and performed→Gate Change→Output Port Change
9) The generated offspring is input to the next generation population (line 13).
10) Step 5) to step 9) for each species (line 10 and line 14) are repeated as many times as the offspring size to be reproduced. For example, 7) to 9) (line 10 and line 14) are repeated until Rk offsprings Cj are added to the next population Pg+1.

### —Things to be Done for Each Step End—

11) Speciate (line 16). Offsprings of the next generation population Pg+1 are compared with a gene of a representative offspring of the known species and, when the offsprings of the next generation population is similar to gene, the offsprings of the next generation population is added to the known species. When there are no similar species, a new species is generated and a corresponding offspring is input to species and is set as a representative offspring.
12) When classification is completed, processes 1) to 11) are repeated with the generated next generation population up to a maximum generations (line 1 and line 17).
13) After the last maximum generation is completed and the algorithm of FIG. 5 is completed, all species are removed, and the offspring with excellent fitness is extracted as a candidate circuit structure.

FIG. 6 is pseudocode of a transistor size optimization process according to an embodiment.

Step S2 is performed on a candidate circuit structure selected in step S1. In step S2, a reinforcement learning algorithm is executed to perform precise transistor size optimization.

In this process, sizes of respective transistors are optimized to provide high performance in all process corners by continuously reflecting process mutations. That is, the circuit performance is continuously checked at respective process corners (for example, TT, SS, FF, SF, FS, and so on) to check the expected worst-case performance, and optimization is performed to improve the expected worst-case performance.

As a result, the finally obtained circuit may secure high performance while operating normally in all process corners.

The multiple process corners include a TT corner, an FF corner, an SS corner, an FS corner, and an SF corner, and step S2 includes a step of executing the reinforcement learning algorithm based on the worst case performance among performances of the candidate circuit structures identified in each process corner.

A state of the reinforcement learning algorithm according to the embodiment is expressed as a vector based on the circuit performance and area of the candidate circuit structure.

The action is a change in transistor size and corresponds to a vector representing a relative size change for all transistors in the candidate circuit structure. For example, the size of a transistor includes a width, a length, a multiplier.

Reward may be determined according to a reward function, and for example, the reward function may use the same function as the fitness function of Equation 1. Here, the score (f(qi,x) of Equation 1) of the reward function is obtained from different process corners (for example, mutation may occur in all process corners including a TT corner, an FF corner, an SS corner, an FS corner, SF corners, and so on), and reward may be determined based thereon.

Step S2 includes a step of executing a reinforcement learning algorithm.

For example, the step of executing a reinforcement learning algorithm may include a step of executing a learner by using the processor 110 to generate a plurality of agents based on a reinforcement learning network and to update the reinforcement learning network based on a sample received from the plurality of agents (learner: line 3 to line 9) and, a step of executing the plurality of agents by using the processor 110 and providing the sample to the learner (agent: line 1 to line 10).

Here, the step of providing the sample may include a step (agent: line 5) of executing, by each of the plurality of agents, an action associated with a change in transistor size of a candidate circuit structure based on a current state, a step (agent: line 6) of determining a next state s by the action and reward r, and a step of generating a sample based on the current state, the action, the next state, and the reward and transferring the generated sample to the learner (agent: line 7).

Here, the learner waits for a sample to arrive from the plurality of agents (learner: line 4). For example, the sample is stored in the memory 120 (for example, a replay buffer that may be accessed by the processor 110), and the learner may select the sample (learner: line 6) and update the reinforcement learning network.

Meanwhile, step S2 may implement an episode early stopping technique. To this end, the step of providing the sample may include a step of performing the action (agent: line 5), a step (agent: line 4 and line 8) of repeating the step (agent: Line 6) of determining, by a predetermined number of repetitions K, the next state and reward and the step (agent: line 7) of transferring the next state and reward, and a step (agent: line 9) of increasing the number of repetitions K at each predetermined interval (T episodes).

The episode early stopping technique may prevent results of incorrect learning from being reflected too significantly by making a length of the episode relatively short at the beginning of learning in order to solve the problem that the action generated each time has a high probability of going in the wrong direction due to the algorithm not being sufficiently trained in the early stages of reinforcement learning.

Step S2 includes a step (learner: line 3 to line 9) of updating the reinforcement learning network, a step (learner: line 6) of selecting a sample having a predetermined batch size among the received samples, and a step (learner: line 7 and line 8) of updating the reinforcement learning network based on the selected sample.

In addition, step S2 may implement a multiple update technique.

To this end, the step of updating the reinforcement learning network may include a step (learner; line 6) of selecting a sample by a predetermined number of updates U and a step (learner: line 5 and line 9) of repeating the step (learner: line 7 and line 8) of updating the reinforcement learning network.

In order to reduce a delay that occurs in obtaining a sample from a simulation result due to a slow simulation speed, the multiple update technique samples a mini batch multiple times when a sample is added to the memory 120 (for example, the replay buffer) (line 4), and accordingly, a learning speed may be increased by performing sampling (learner: line 5 to line 9) multiple times.

The pseudocode for each line will be described again with reference to FIG. 6.

Referring to FIG. 5, step S2 performs transistor size optimization by executing a reinforcement learning algorithm on the candidate circuit structure generated in step S1.

For example, a reinforcement learning network may use distribute distributional deterministic policy gradients (D4PG) including one exploration agent, one critic, one exploration agent, and one target critic.

### —Operation of Learner—

1) A circuit is analyzed to determine an input and output size of a network (learner: line 1).

For example, because the number of states of an actor network used by an agent that generates an action is fixed, an output size is (the number of transistors×3) of a circuit. Because an output of a critic network is fixed, the input is (the number of states+number of transistors×3). Thereafter, an exploitation agent and a target critic network are generated. For example, the actor network may use multi-layer perceptron (MLP) but is not limited thereto.
2) The weight of a network is initialized through Kaiming Initialize (learner: line 2).
3) An exploration agent is generated by copying the exploitation agent. The critic network is generated by copying the target critic network. An exploration agent value is copied to generate n agents (learner: line 2).
4) Among n agents, transferring asynchronously a sample is waited (learner: line 4).
5) When one sample is transferred, the sample is stored in a replay memory (learner: line 4).
6) A sample is randomly selected from the replay memory by a batch size (learner: line 6).
7) Update is calculated (backpropagation) (learner: line 7)
8) An exploration agent and a critic network are updated (learner: line 8). Thereafter, the exploitation agent and the target critic network reflect weight values of the exploration agent and critic network by performing a weighted moving average.
9) Processes of 6) to 9) are repeated as many times as the number of multi-updates U (learner: line 5 and line 9).
10) Processes of 4) to 9) are repeated until the sample is repeated by the number of updates N (learner: line 3 and line 10).

### —End of Operation of Learner—

### —Operation of Agent—

After the agent is generated by the learner, the exploration agent values are respectively copied to the n agents.
1) Episode initialization (agent: line 2): A circuit is initialized. A state is also changed to an initial state.
2) A weight value of the exploration agent is copied (agent: line 3).
3) A state is input to an actor network to obtain an action value (agent: line 5).
4) A transistor size is changed through the action value (agent: line 5).
5) A circuit having the changed size is simulated (agent: line 6).
6) The state and reward are calculated through a circuit simulation result (agent: line 6). The state is processed through, for example, equations in Table 1 below. The reward is processed with the equations in Table 1 and is obtained by multiplying by weight.

TABLE 1

| | | Topology Generator | Circuit Optimizer |
|---|---|---|---|
| Generation & Step | | 400 | 350,000 |
| Process Corners | | TT | TT/FF/SS/FS/SF |
| Hard | Swing | q_{i,x}/V_{DDH} | q_{i,x} /V_{DDH} |
| Constraint | Ratio | | |
| Soft | Delay | −logq_{i,x} + b | −logq_{i,x} + b |
| Constraints | Pₜₒₜₐₗ | −logq_{i,x} + b | −logq_{i,x} + b |
| | P_{static} | −logq_{i,x} + b | −logq_{i,x} + b |
| | Area | $1 - \frac{max ( {q}_{i , x} - b , 0 )}{slope}$ | −logq_{i,x} + b |

7) A total of four elements including {state input to the actor network in 3)}, {action}, {state obtained in 6)}, and {reward} are generated as samples and transferred to a learner (agent: line 7).
8) Processes of 3) to 7) are repeated K times (agent: line 4 and line 8).
9) When repeated K times, one episode is completed. Every time the episode is repeated T times, K is increased (agent: line 9).
10) Processes of 1) to 9) are repeated until the learner is finished (agent: line 1 and line 10).

Meanwhile, as described above with reference to FIG. 5, relative voltages of nodes of the circuit topology graph are included in one property of a node gene, and the circuit design method according to the embodiment may further include a step of determining a relative voltage of the edge based on relative voltages of nodes at both ends of the edge of the circuit topology graph representing an optimized candidate circuit structure, and a step of converting a transistor associated with the edge in the optimized candidate circuit structure into a PMOS transistor or an NMOS transistor according to the relative voltages of the edge.

The method according to the embodiment of the present disclosure described above may be implemented as computer-readable code on a non-transitory recording medium on which a program is recorded. Non-transitory computer-readable recording media include all types of recording devices that store data readable by a computer system. For example, the non-transitory computer-readable recording media include a hard disk drive (HDDs), a solid state disk (SSD), a silicon disk drive (SDD), ROM, RAM, compact disk-ROM (CD-ROM), a magnetic tape, a floppy disk, an optical data storage device, and so on.

Advantages of the framework proposed by the present disclosure and differentiation thereof compared to the known research are as follows.
A framework according to an embodiment consists of two steps of circuit structure search (topology generation) and transistor size optimization. Therefore, there is an advantage in that optimal performance is not required to be secured in the first step and a topology generation process may be performed very quickly because candidates of a circuit structure with relatively good performance need to be found out.
The circuit design method and device according to the embodiment has the possibility of finding a new circuit structure that is not reported to academia/industry during ae circuit structure search process. A new circuit structure with higher performance than the known structure may be obtained in an actual experiment process and may be implemented very quickly during the process, and thus, there is a high potential for designing differentiated circuits.
In the process of exploring a circuit structure of the framework according to the embodiment, each circuit is represented as a circuit topology graph, and relative voltages are introduced into the circuit topology graph. By mapping a node as a PMOS transistor when the relative voltage is high and as an NMOS transistor when the relative voltage is low, a circuit structure optimized for a CMOS process may be automatically found.
The known transistor size optimization technique perform only the size optimization in a state where the circuit structure is fixed, and thus, the circuit performance is improved to be less. However, the framework according to the embodiment has the advantage of having much greater room for performance improvement because the framework starts from a process of finding an excellent circuit structure.
The known transistor size optimization technique does not reflect process mutation, thereby, having limitations in that performance may not be guaranteed when actually manufacturing integrated circuits (ICs). However, the framework according to the embodiment performs optimization by continuously reflecting a process corner, and thus, it is guaranteed to operate normally in all process corners.
It can be seen that, by applying the circuit design automation framework according to the embodiment to a level shifter that is commonly used in a digital circuit, the framework according to the embodiment has very superior performance as a result of design and experimentation, compared to the level shifter circuit designed by an expert. In addition, a circuit is manufactured as an actual IC through a TSMC 180 nm CMOS process, and as a result of measurement, performance is improved to be at least 2 to 5 times compared to the level shifter circuit reported in academia.
The circuit design automation framework according to the embodiment may be directly applied not only to level shifters but also to other types of circuits, such as analog amplifiers.

Meanwhile, the circuit design method and device according to the embodiment automates the entire circuit design process by using an artificial intelligence algorithm, and the applied technique is not limited by the circuit structure, and thus, the circuit design method and device may be directly applied to circuit designs of various types. Also, the optimization algorithm according to the embodiment is not limited to the reinforcement learning algorithm, and other types of artificial intelligence algorithms may be applied thereto.

Also, the circuit design method and device according to the embodiment may be applied to circuit design to be verified in an actual CMOS process and shows superior performance compared to the reported circuit design result and has high practicality. The circuit design method and device according to the embodiment may be immediately used based on a cost function depending on types of a circuit desired by a demand company.

The description of the embodiments according to the present disclosure described above is for illustrative purposes, and those skilled in the art to which the present disclosure pertains may understand that the present disclosure may be easily transformed into another specific form without changing the technical idea or essential features of the present disclosure. Therefore, the embodiments described above should be understood in all respects as illustrative and not restrictive. For example, each component described as single may be implemented in a distributed manner, and similarly, components described as distributed may also be implemented in a combined form.

The scope of the present disclosure is indicated by the claims described below rather than the detailed description above, and all changes or modified forms derived from the meaning and scope of the claims and their equivalent concepts should be construed as being included in the scope of the present disclosure.

What is claimed is:

1. A circuit design method performed by a circuit design apparatus including a processor, the circuit design method comprising:
generating, by a processor, a candidate circuit structure by executing a genetic algorithm based on a gene and associated with a circuit topology graph; and
optimizing, by the processor, a transistor size of the candidate circuit structure by executing a reinforcement learning algorithm based on analysis of multiple process corners.

2. The circuit design method of claim 1, wherein
the gene includes a node gene linked to nodes of the circuit topology graph and configured to reflect node property of a circuit structure, and a connection gene linked to an edge of the circuit topology graph and configured to reflect transistor property of the circuit structure.

3. The circuit design method of claim 2, wherein
the node gene includes a node type, a relative voltage of the node, and a node identifier, and
the connection gene includes a source, a drain, a size, a gate, and a connection identifier.

4. The circuit design method of claim 1, wherein
the gene includes a relative voltage of a node of the circuit topology graph, and
the circuit design method further comprises:
determining a relative voltage of an edge based on relative voltages of nodes at both ends of an edge of the circuit topology graph representing an optimized candidate circuit structure; and
converting a transistor associated with the edge in the optimized candidate circuit structure into a PMOS transistor or an NMOS transistor according to the relative voltages of the edge.

5. The circuit design method of claim 1, wherein
the generating of the candidate circuit structure includes executing the genetic algorithm,
the executing of the genetic algorithm includes generating a new offspring from an offspring belonging to a current population for each species to which the offspring belongs, and
the generating the new offspring includes generating the new offspring by crossing over a pair of offsprings, which are selected from a parent pool including at least some of offsprings belonging, from the offspring belonging to the current population for each species to which the offspring belongs, performing mutation on the new offspring, and adding a mutated offspring to a next generation population.

6. The circuit design method of claim 5, wherein
the performing of the mutation includes performing probabilistically a transistor size change, connection removal, addition, a gate change, and an output port change, and
the addition is one of connection addition, node addition, and addition of a PMOS transistor and an NMOS transistor.

7. The circuit design method of claim 5, wherein the executing of the genetic algorithm further includes:
determining fitness of species based on fitness of the offspring belonging to the current population;
determining a reproduction size of each species based on the fitness of species;
repeating the generating of the new offspring as many times as a reproduction size for each species;
classifying species of offspring belonging to the next generation population;
repeating, for a maximum number of generations, the determining of fitness for each species by using the next population as the current population, determining of the reproduction size for each species, repeating of the generating of the new offspring, and classifying of the species; and
extracting an offspring with the highest fitness for each species as the candidate circuit structure.

8. The circuit design method of claim 1, wherein
the multiple process corners include a TT corner, an FF corner, an SS corner, an FS corner, and an SF corner, and
the optimizing of the transistor size includes executing the reinforcement learning algorithm based on worst case performance among performances of the candidate circuit structure identified in each process corner.

9. The circuit design method of claim 1, wherein
the optimizing of the transistor size includes executing the reinforcement learning algorithm, and
the executing of the reinforcement learning algorithm includes:
updating a reinforcement learning network based on a sample received from the plurality of agents by executing a learner by using the processor to generate a plurality of agents based on the reinforcement learning network; and
providing the sample to the learner by executing the plurality of agents by using the processor.

10. The circuit design method of claim 9, wherein
the providing of the sample includes executing, by each of the plurality of agents, an action associated with a change in a transistor size of the candidate circuit structure based on a current state;
determining, by each of the plurality of agents, a next state of the action and reward;
transferring, by each of the plurality of agents, the generated sample to the learner by generating a sample based on the current state, the action, the next state, and the reward;
repeating by a predetermined number of repetitions the executing of the action, the determining of the reward, and the transferring of the action; and
increasing the number of repetitions at each predetermined interval.

11. The circuit design method of claim 9, wherein
the updating of the reinforcement learning network includes selecting a sample having a predetermined batch size from among received samples;
updating the reinforcement learning network based on a selected sample; and
repeating the selecting of the sample by a predetermined number of update times and the updating of the reinforcement learning network.

12. A circuit design apparatus comprising:
a memory storing at least one instruction; and
a processor,
wherein, when the at least one instruction is executed by the processor, the processor is configured to generate a candidate circuit structure by executing a genetic algorithm based on a gene and associated with a circuit topology graph and to optimize a transistor size of the candidate circuit structure by executing a reinforcement learning algorithm based on analysis of multiple process corners.

13. The circuit design apparatus of claim 12, wherein
the gene includes a node gene linked to nodes of the circuit topology graph and configured to reflect node property of a circuit structure, and a connection gene linked to an edge of the circuit topology graph and configured to reflect transistor property of the circuit structure.

14. The circuit design apparatus of claim 12, wherein
the gene includes a relative voltage of a node of the circuit topology graph, and
when the at least one instruction is executed by the processor, the processor is further configured to determine a relative voltage of an edge based on relative voltages of nodes at both ends of an edge of the circuit topology graph representing an optimized candidate circuit structure, and converts a transistor associated with the edge in the optimized candidate circuit structure into a PMOS transistor or an NMOS transistor according to the relative voltages of the edge.

15. The circuit design apparatus of claim 12, wherein, when the at least one instruction is executed by the processor,
the processor is further configured to generate a new offspring from an offspring belonging to a current population for each species to which the offspring belongs, and
in order to generate the new offspring, the process is further configured to generate the new offspring by crossing over a pair of offsprings, which are selected from a parent pool including at least some of offsprings belonging, from the offspring belonging to the current population for each species to which the offspring belongs, to perform mutation on the new offspring, and to add a mutated offspring to a next generation population.

16. The circuit design apparatus of claim 15, wherein
in order to perform the mutation, when the at least one instruction is executed by the processor, the process is further configured to perform probabilistically a transistor size change, connection removal, addition, a gate change, and an output port change, and
the addition is one of connection addition, node addition, and addition of a PMOS transistor and an NMOS transistor.

17. The circuit design apparatus of claim 15, wherein, in order to execute the genetic algorithm, when the at least one instruction is executed by the processor, the processor is further configured to
determine fitness of species based on fitness of the offspring belonging to the current population;
determine a reproduction size of each species based on the fitness of species;
repeat the generating of the new offspring as many times as a reproduction size for each species;
classify species of offspring belonging to the next generation population;
repeat, for a maximum number of generations, the determining of fitness for each species by using the next population as the current population, determining of the reproduction size for each species, repeating of the generating of the new offspring, and classifying of the species; and
extract an offspring with the highest fitness for each species as the candidate circuit structure.

18. The circuit design apparatus of claim 12, wherein
the multiple process corners include a TT corner, an FF corner, an SS corner, an FS corner, and an SF corner, and
in order to optimize the transistor size, when the at least one instruction is executed by the processor, the processor is further configured to execute the reinforcement learning algorithm based on worst case performance among performances of the candidate circuit structure identified in each process corner.

19. The circuit design apparatus of claim 12, wherein
in order to execute the reinforcement learning algorithm, when the at least one instruction is executed by the processor execute a learner to generate a plurality of agents based on a reinforcement learning network and update the reinforcement learning network based on a sample received from the plurality of agents, and
in order to update the reinforcement learning network, when the at least one instruction is executed by the processor, the processor is further configured to repeat, by a predetermined number of update times, an operation of selecting a sample having a predetermined batch size from among received samples and an operation of updating the reinforcement learning network based on a selected sample.

20. The circuit design apparatus of claim 19, wherein
when the at least one instruction is executed by the processor, in order to provide the sample, the processor is further configured to repeat, by a predetermined number of repetitions, an operation of executing an action associated with a change in a transistor size of the candidate circuit structure based on a current state by using each of the plurality of agents, an operation of determining a next state of the action and reward by using each of the plurality of agents, and an operation of generating a sample based on the current state, the action, the next state, and the reward by using each of the plurality of agents and transferring the generated sample to the learner by using each of the plurality of agents, and
the processor is further configured to increase the number of repetitions at each predetermined interval.
